(19) United States
(12) Patent Application Publication
(10) Pub. No.: US 2025/0139504 A1
(43) Pub. Date: May 1, 2025

(54) SENSOR DATA INCORPORATION FOR MULTI-MODAL MACHINE LEARNING MODELS

(71) Applicant: Dell Products L.P., Round Rock, TX (US)

(72) Inventors: Herberth Birck Frohlich, Florianópolis (BR); Vinicius Michel Gottin, Rio de Janeiro (BR); Paulo Abelha Ferreira, Rio de Janeiro (BR)

(73) Assignee: Dell Products L.P., Round Rock, TX (US)

(21) Appl. No.: 18/498,889

(22) Filed: Oct. 31, 2023

(51) Int. Cl. G06N 20/00

(52) U.S. Cl. CPC G06N 20/00

(57) ABSTRACT

Techniques are disclosed for incorporating sensor data for multi-modal machine learning (ML) models. An example method includes: determining class indications for sensor data samples by applying an ML label model to each sensor data sample, the sensor data samples including a dataset obtained from preinstalled sensors thereby defining existing sensor data, a dataset obtained from newly installed sensors thereby defining new sensor data, and a dataset obtained by combining the preinstalled and the newly installed sensors thereby defining combined sensor data; comparing an initial class determined using initial labels for the existing sensor data with new classes derived using the class indications that are determined for the new sensor data and for the combined sensor data, to determine an agreement measure among the compared classes; and using the agreement measure to perform update processing on an ML target model.

### FIELD

Example embodiments generally relate to retraining of machine learning models. More specifically, at least some embodiments relate to systems, hardware, software, computer-readable media, and methods for assessing whether to retrain machine learning models to incorporate features from data samples from heterogeneous sensors.

### BACKGROUND

In the context of machine learning operation, a deployed multi-modal model can receive data from a number of sensors. There could be a situation where one or more new heterogeneous sensors are added to the process. Unfortunately, it is not trivial to assess whether this new information is useful to the model without retraining.

Difficulties that can arise during this evaluation include expensive annotation of observations coming from these newly added sensors, retraining an existing model or training a new model is required to determine whether the updated model would outperform the previous one, and a priori statistical analysis is difficult because of the heterogeneity of the sensors.

### SUMMARY

Techniques are disclosed for incorporating sensor data for multi-modal machine learning (ML) models.

In an embodiment, a system includes at least one processing device including a processor coupled to a memory. The at least one processing device being configured to implement the following steps: determining class indications for sensor data samples by applying an ML label model to each sensor data sample, the sensor data samples including a dataset obtained from preinstalled sensors thereby defining existing sensor data, a dataset obtained from newly installed sensors thereby defining new sensor data, and a dataset obtained by combining the preinstalled and the newly installed sensors thereby defining combined sensor data; comparing an initial class determined using initial labels for the existing sensor data with new classes derived using the class indications that are determined for the new sensor data and for the combined sensor data, to determine an agreement measure among the compared classes; and using the agreement measure to perform update processing on an ML target model.

In some embodiments, the update processing includes: determining that the agreement measure indicates agreement among at least a subset of the compared classes that a given label represents the class for the corresponding dataset at a given timestamp, and in response to the agreement, enhancing the target model by retraining the target model to incorporate features represented by the new sensor data or by the combined sensor data. A magnitude of the enhancement can be derived using a permutation test score that is determined based on the agreement measure. The update processing can include: determining that the agreement measure indicates disagreement among the compared classes that a given label represents the class for the sensor data samples, and, in response to the disagreement, refraining from retraining the target model to incorporate features represented by the sensor data samples from the newly installed sensor. The initial labels can be determined using a label model LabelModel_{old}, or using golden labels obtained from an oracle for the existing sensor data. The new classes can be determined using a label model LabelModel_{new} that is applied to the new sensor data, and using a label model LabelModel_{both} that is applied to the combined sensor data. The new classes can be determined by: using the label model LabelModel_{new} and LabelModel_{both} to obtain class probabilities for the new sensor data and for the combined sensor data respectively at a given timestamp; and using the class probabilities to determine respective class indications representing the new classes. The class indication can be determined based on a probability per class, thereby defining a class probability, and the class probability can be obtained from the label model using one or more labeling functions. The class indication can include an indicator that represents whether the class probability exceeds a predetermined threshold. The indicator can be a Boolean indicator. The label model can be trained using programmatic labeling. The target model can be a classifier model.

Other example embodiments include, without limitation, apparatus, systems, methods, and computer program products comprising processor-readable storage media.

Other aspects will be apparent from the following detailed description and the amended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 discloses aspects of an example programmatic labeling pipeline, in accordance with illustrative embodiments;

FIG. 2 discloses aspects of an example retraining assessment architecture, in accordance with illustrative embodiments;

FIG. 3 discloses aspects of an example initialization stage, in accordance with illustrative embodiments;

FIG. 4 discloses aspects of an example class indications stage, in accordance with illustrative embodiments;

FIG. 5 discloses aspects of an example class agreement stage, in accordance with illustrative embodiments;

FIG. 6 discloses aspects of an example permutation test score stage, in accordance with illustrative embodiments;

FIG. 7 discloses a flowchart of an example method, in accordance with illustrative embodiments; and

FIG. 8 discloses aspects of a computing entity configured and operable to perform any of the disclosed methods, process, and operations, in accordance with illustrative embodiments.

### DETAILED DESCRIPTION

Example embodiments generally relate to retraining of machine learning (ML) models. More specifically, at least some embodiments relate to systems, hardware, software, computer-readable media, and methods for assessing whether to retrain ML models to incorporate features from data samples from heterogeneous sensors.

Disclosed herein are techniques for efficient incorporation of sensor data into multi-modal models. Example embodiments extend and adapt a programmatic labeling approach to determine whether a new model would be desirable (e.g., retraining a target model to incorporate features representing data samples from heterogeneous sensors). Advantageously, some embodiments leverage intermediate results from programmatic labeling (such as labeling function and label model outputs) to incorporate new sensor modalities to an existing target operational model, and accordingly decide efficiently whether such target model is worth the retraining cost.

The disclosed techniques are operable in the context of ML operations, where a deployed multi-modal model receives data from a certain number of heterogenous sensors, e.g., sensors for different purposes such as Inertial Measurement Units versus cameras.

Technical problems arise in a situation where one or more new heterogeneous sensors are added to the process, and it is challenging to assess whether this new information is useful to the target model, without retraining. More particularly, the following are technical problems arising during this evaluation:
Expensive annotation of observations coming from these new added sensors
Training a new model is required to determine whether a new model would perform than the previous one. However, retraining is expensive and costly.
A priori statistical analysis is made difficult because of sensor heterogeneity.

Example embodiments of the present solution can be provided as a service in the context of machine learning operations (MLOps) or can enhance edge operations that rely on sensor-based monitoring.

The disclosed techniques provide a technical solution that addresses the technical problems presented above, as follows:
The disclosed architecture uses intermediary results from programmatic labeling to assimilate new sensor modalities to an existing target operational model.
The disclosed techniques allow for efficient determination of whether a model is worth the retraining cost.

Specific embodiments will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### A. Context for an Example Embodiment

The following is a discussion of a context for example embodiments. This discussion is not intended to limit the scope of the invention, or the applicability of the embodiments, in any way.

Regarding use of a priori statistics, significance and other statistical tests operable to determine whether new sensors/features are worth adding to a given ML target model are conventionally only possible for homogenous sensors. An approach is needed that enables heterogeneous sensors to be considered in whether new sensors/features are worth adding to a given ML target model.

### A.1. Programmatic Labeling

Example embodiments leverage intermediate outputs from programmatic labeling to extract information and make various assumptions. Accordingly, a brief overview of programmatic labeling is presented herein.

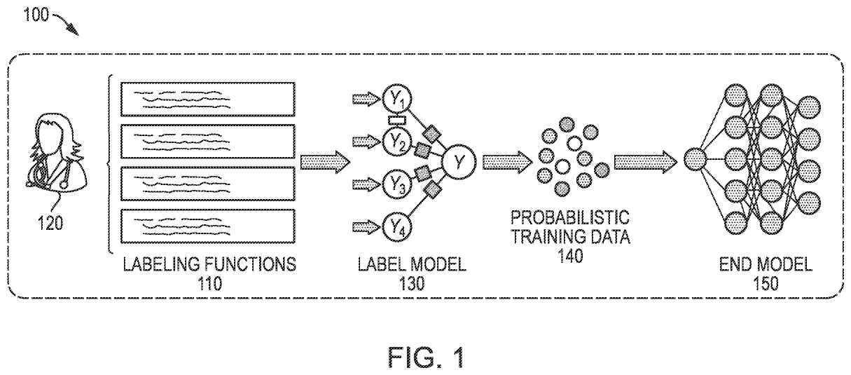

FIG. 1 shows aspects of an example programmatic labeling pipeline 100, in accordance with illustrative embodiments. Programmatic labeling refers to a data-centric approach to increase the quality of automatic labeling by using labeling functions 110 and a small portion of true labels (or even no labels) to label observations at scale in a traceable way.

In example embodiments, the labeling functions 110 can be heuristics created by subject matter experts 120 or even by trained models. These labeling functions are applied on a given dataset such as sensor data samples. The labeling functions may conflict, have superposition, or provide “abstain” votes.

In example embodiments, a label model 130 is configured to incorporate the labeling function 110 outputs for a given observation into a single, probabilistic label. The disclosed techniques leverage this intermediate output of the label model, such as the probabilistic output, among other information, to provide an assessment of whether retraining an end model 150 is worth the associated effort.

In example embodiments, probabilistic training data 140 aggregates the probabilistic label outputs from the label models 130.

In example embodiments, the end model 150 is trained using the probabilistic training data 140. The label model 130 lacks generalization, so programmatic labeling involves training a second machine learning model using the probabilistic training data. In some implementations, the end model (sometimes referred to herein as a target model or an operational model) is a discriminative model with generalization capabilities. Further details regarding programmatic labeling are provided in A. Ratner, S. Bach, H. Ehrenberg, et al., “SNORKEL: Rapid Training Data Set Creation with Weak Supervision,” THE VLDB J., vol. 29 (2020), the entire contents of which are incorporated by reference herein for all purposes.

### B. Overview of Aspects of an Example Embodiment

In general, the present retraining assessment leverages the particular output of intermediary results in advantageous ways, as discussed in further detail herein.

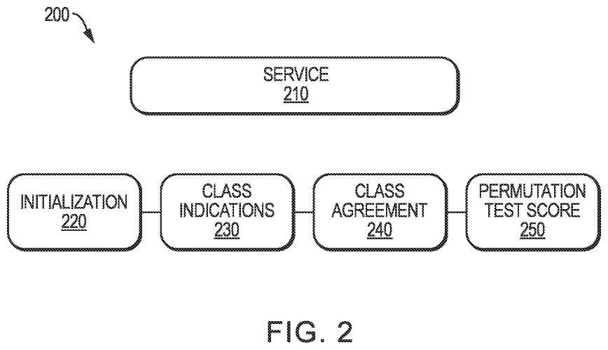

FIG. 2 shows aspects of an example retraining assessment solution 200, in accordance with illustrative embodiments. In particular, FIG. 2 illustrates an example embodiment of the retraining assessment solution configured to process sensor data samples and perform update processing on a target model.

In example embodiments, service 210 can implement the present retraining assessment techniques. As used in the context of the disclosed embodiments, the term “service” refers to an automated program that is tasked with performing different actions based on input. In some cases, the service can be a deterministic service that operates fully given a set of inputs and without a randomization factor. In other cases, the service can be or can include a ML or artificial intelligence engine. The ML engine enables the service to operate even when faced with a randomization factor.

As used in the context of disclosed embodiments, reference to any type of machine learning or artificial intelligence may include any type of machine learning algorithm or device, convolutional neural network(s), multilayer neural network(s), recursive neural network(s), deep neural network(s), programmatic labeling model(s), classifier model(s), decision tree model(s) (e.g., decision trees, random forests, and gradient boosted trees) linear regression model(s), logistic regression model(s), support vector machine(s) (SVM), artificial intelligence device(s), or any other type of intelligent computing system. Any amount of training data may be used (and perhaps later refined) to train the machine learning algorithm to dynamically perform the disclosed operations. As discussed in further detail herein, example training data can include features and labels derived from sensor data samples obtained from preexisting sensors and newly installed sensors.

In some implementations, the service 210 is a cloud service operating in a cloud environment. In some implementations, the service is a local service operating on a local device, such as a server. In some implementations, the service is a hybrid service that includes a cloud component operating in the cloud and a local component operating on a local device. These two components can communicate with one another.

The disclosed solution 200 concerns a scenario in which an existing target model is in operation (e.g., a classification model), and a new modality of sensors is deployed and/or considered. Example embodiments extend and adapt a programmatic labeling approach to determine whether a new model would be desirable (e.g., retraining the target model to obtain a new model that includes features corresponding to the new modality of heterogeneous sensors).

As discussed, programmatic labeling is a process that translates heuristics into labeling functions so that a target model can be trained to tag observations without the need of true labels.

In example embodiments, the retraining assessment solution 200 includes an initialization stage 220. In some implementations, a new modality of sensors is added to a domain, with sensors (Sₗ . . . S_{z}). A dataset D_{new} contains sensor data samples with feature (1 . . . z), but no true labels. Some embodiments of the initialization stage link the samples within a given time interval to enable comparison of the respective labels for each feature.

In example embodiments, the retraining assessment solution 200 includes a class indications stage 230. Some embodiments start with a trained multi-modal model M for a set of heterogenous sensors (S₁ . . . Sₖ). In further embodiments, the model was trained considering one of the following situations:
a) golden labels were available (e.g., via expensive annotation) or a way to generate it; or
b) programmatic labeling was previously applied in the form of labeling functions

In example embodiments, in situation b) of previously applied programmatic labeling, it can be presumed that a set of labeling functions is already available for the original dataset and all original sensors. Otherwise, in situation a) those labeling functions can be created, or golden labels can be used.

In example embodiments, the present disclosure splits the generation of a label model, as used in programmatic labelling, into two. More particularly, one label model LabelModel_{old} is based on label functions that do not refer to the new modality of sensors, and one label model LabelModel_{new} is based on the label functions that do refer to the new modality of sensors. The present techniques also leverage labeling functions and a corresponding label model LabelModel_{both} if all sensors are combined.

In example embodiments, the retraining assessment solution 200 includes a class agreement stage 240. The disclosed techniques leverage the resulting class probabilities yielded for each sensor sample during the class indications stage 230 and compare the class probabilities in the class agreement stage. In some implementations, the results may indicate that the addition of the new modality of models does not pay off.

In example embodiments, the retraining assessment solution 200 includes a permutation test score stage 250. The usefulness of the new label is checked, for example using an adapted permutation test score.

In the case of more than one sensor to be added, there can be a process for each newly installed sensor. Additional considerations can address interactions between multiple newly installed sensors. In general, the results depend on the quality of the labeling functions, such as those labeling functions used to label a datastream D_{new} of sensor data samples from the newly installed sensor(s).

### C. Detailed Description of an Example Embodiment

### C.1. Initialization

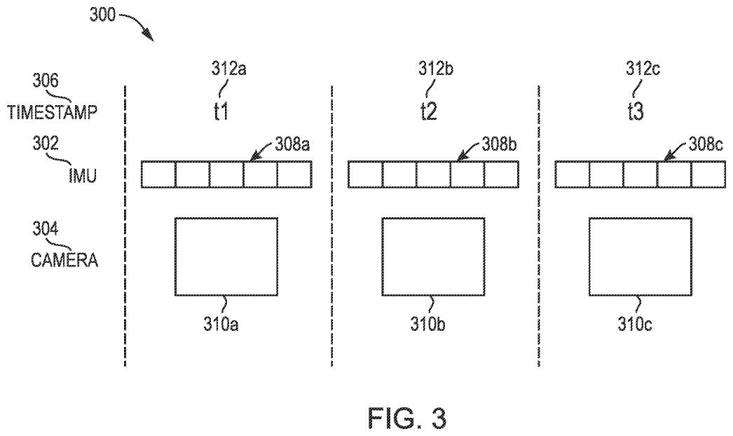

FIG. 3 shows aspects of an example initialization stage 300, in accordance with illustrative embodiments.

Example embodiments of the initialization stage 300 (an example of the initialization stage 220) begin with acquisition of a dataset. In some implementations the dataset includes D_{old} and D_{new}. D_{old} contains observations (e.g., sensor data samples) related to the preinstalled sensors (S₁ . . . Sₖ). D_{new} contains observations (e.g., sensor data samples) related to the newly installed sensors (Sₗ . . . S_{z}).

In some embodiments, some sensors might have a larger or smaller frequency. Phrased differently, some sensors might provide sensor data with different frequencies and timing compared with other sensors. In such situations, a reduction method can be applied. By way of non-limiting example, an inertial measurement unit (IMU) 302 can be a preexisting sensor that is already collecting sensor data 308a, 308b, 308c at a given timestamp 306 t1 312a, t2 312b, t3 312c. A camera 304 can be a newly installed sensor. In some embodiments, the IMU observations 308a can be averaged within a given time window 312a and an appropriate camera frame 310a can also be selected and linked within that time interval. Linking the preexisting with the newly installed sensors in the disclosed manner allows the label for each feature to compared, as discussed in further detail herein.

More particularly, FIG. 3 shows an example of two heterogeneous sensors 302, 304 arranged in the same timestamp 306. In example embodiments, several sensor data samples of an IMU sensor 302 are averaged and related to a single camera frame at each same time instant t. At timestamp t1 312a, the IMU sensor data samples 308a are linked with the camera sensor data sample (e.g., a video frame) 310a. At timestamp t2 312b, the IMU sensor data samples 308b are linked with the camera sensor data sample (e.g., frame) 310b. At timestamp t3 312c, the IMU sensor data samples 308c are linked with the camera sensor data sample (e.g., frame) 310c.

For example, as shown in FIG. 3, in some embodiments five acquisitions 308a can be averaged to provide a single IMU 302 reading, and a single camera's frame 310a is linked with or related to that same interval 312a.

In example embodiments, it is presumed that D_{old} has trustable labeling functions LF_{old}, or a way to provide categorical golden labels GL. Subject matter experts can provide labeling functions LF_{new} to the datastream D_{new}. In alternate embodiments, features from both D_{old} and D_{new} can feed the labeling functions LF_{both}, without departing from the scope of the embodiments discussed herein.

### C.2. Class Indications

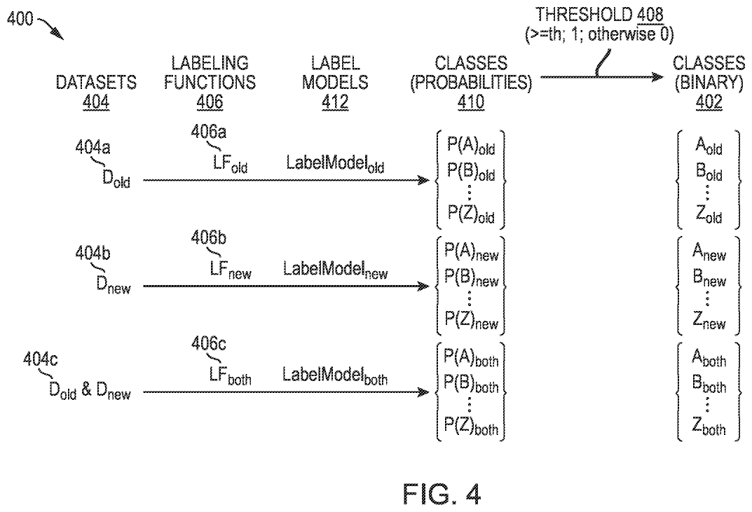

FIG. 4 shows aspects of an example class indications stage 400, in accordance with illustrative embodiments. In example embodiments, the class indications 402 are obtained for the sensor data samples 404a, 404b, 404c from application of labeling functions 406a, 406b, 406c along with a predetermined threshold value 408.

In example embodiments, the labeling functions LF_{old} 406a, LF_{new} 406b and LF_{both} 406c are applied to D_{old} 404a, D_{new} 404b, D_{both} 404c, respectively, and for each observation within the same timestep. In some implementations, each observation provides a vector 410 with one probability P(Class)_{D} per class A . . . Z. This probability comes from a label model 412 (e.g., a label model that is trained using programmatic labeling) or from a similar procedure that yields a class probability.

In some embodiments, it is possible to substitute the golden labels GL, if available, in place of LF_{old}. If GL is chosen, a new target model M* is highly unlikely to provide better results, but new features may increase generalization of the target model M*. Accordingly, the disclosed techniques allow the user to assess whether such model retraining tradeoff is worth the corresponding effort.

### C.3. Class Agreement

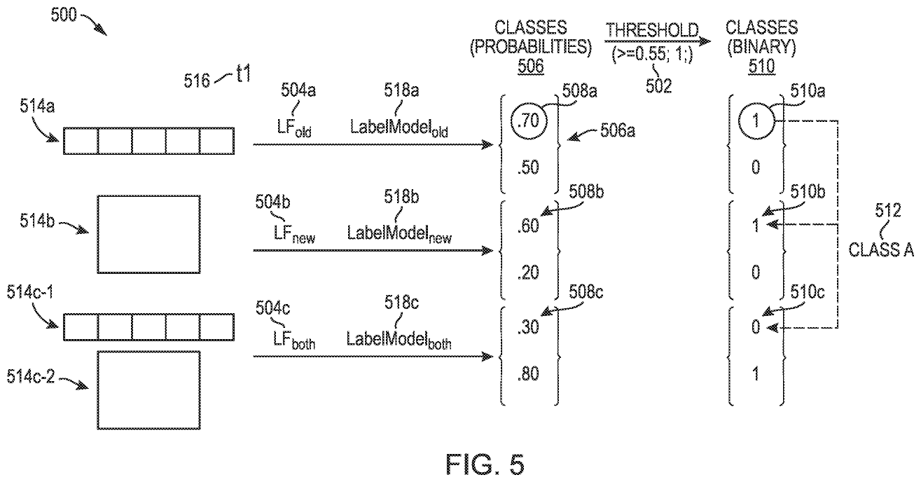

FIG. 5 shows aspects of an example class agreement stage 500, in accordance with illustrative embodiments. With reference to FIGS. 2, 3, and 5, the illustrated class agreement stage (an example of the class agreement stage 240) is shown for the sensors 302, 304 during a single timestamp t1 516.

In example embodiments, a threshold th 502 is applied to all outputs from the labeling functions LF_{old}, LF_{new}, LF_{both} 504a, 504b, 504c, observation-wise. The resulting class 510a from LF_{old} 504a leads the choice of classes of the other LF.

In an example embodiment, the class agreement stage 500 proceeds as follows:
1. For the sensor data sample(s) 514a from the preinstalled sensor(s) at a timestamp t1 516:
   a. Example embodiments obtain the labels from the original label model LabelModel_{old} 518a. In alternate embodiments, the present solution obtains golden labels GL from an oracle (such as from a human), if available.
   b. Example embodiments determine an initial class c 510a for that timestamp 516 indicated by the label model LabelModel_{old} 518a.
2. With the initial class 510a in hand, for each set of respective labeling functions {LF_{new}, LF_{both}} 504b, 504c:
   a. Example embodiments obtain the sensor data sample(s) 514b of the newly installed sensor and the combined sensor data samples 514c-1, 514c-2 at the timestamp t1 516.
   b. Example embodiments obtain the corresponding class probability 508b, 508c for the class c 510a for those sensor data samples 514b, 514c-1, 514c-2 via the appropriate label model (LabelModel_{new}, LabelModel_{both}) 518b, 518c.
   c. Example embodiments obtain a class indication 510, for example, a Boolean class indication (b_{new} and b_{both}) 510b, 510c, for the class c 510a after applying a threshold 502 to that class probability 506, e.g., each respective class probability 508b, 508c.
3. Example embodiments determine an agreement measure. In some implementations, the present retraining assessment determines whether LF_{new} and LF_{both} 504b, 504c agree 510b, 510c with the class 510a determined by LF_{old} 504a. In some implementations this class agreement can be performed by a Boolean check. In alternate embodiments, the class agreement can be implemented as a “majority voting” between b_{new}, b_{both} and 1 (considering that c always corresponds to the value 1, e.g., a vote for class c, for this calculation).
4. Example embodiments use the agreement measure to perform update processing on an ML target model, as follows:
   a. In some embodiments, if the respective classes 510a, 510b, 510c agree as determined by the corresponding labeling functions 504a, 504b, 504c, then a class label 512 is returned (e.g., class A, as illustrated in FIG. 5). In further embodiments, the update processing can include determining a magnitude of enhancement or penalization for retraining the target model to incorporate the new feature represented by the newly installed sensors. Some implementations can determine the magnitude using a permutation test score, as discussed in further detail herein.
   b. In some embodiments, if the respective classes disagree, then an “abstain” vote is returned. Advantageously, the “abstain” vote can indicate that the new feature would not be useful to the target model, and accordingly the addition of the new modality of models can be omitted, thereby saving the complexity and effort that would otherwise be incurred by retraining the target model.

In example embodiments, in general, class agreement (e.g., majority voting) results in a single label 512. In alternate embodiments, a draw causes an “abstain” for that timestep 516, resulting in the observation being omitted.

### C.4. Permutation Test Score

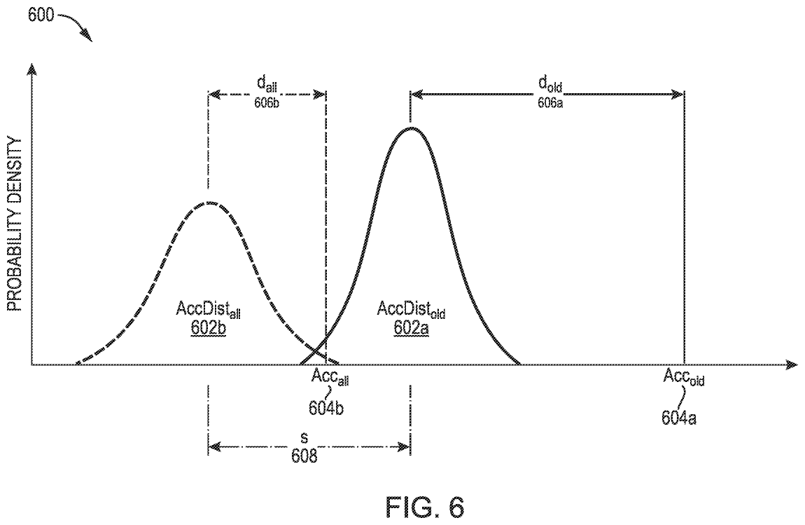

FIG. 6 shows aspects of an example permutation test score stage 600, in accordance with illustrative embodiments.

As discussed, example embodiments include a class agreement stage that merges knowledge and yields two scenarios. In one scenario, if one or both other labeling functions LF_{new} and LF_{both} provide agreement on the same class as the existing labeling function LF_{old}, then the target model M will be enhanced by that new feature representing the newly installed sensors, otherwise the model will be penalized. In some implementations, the magnitude of this enhancement or penalization is calculated using a permutation test score stage 600 (an example of the permutation test score stage 250) for model selection.

A permutation test score, as applied to model selection, refers to a statistical test that analyses the influence of new features by breaking down the relation between observations and labels. In particular, the permutation test score checks if the original accuracy was not achieved by chance, as obtained using a hypothesis test: the more distant the distribution from the unit value of accuracy, the smaller the p-value, representing a lower chance that that structure between observations and labels is by chance. Further details of the permutation test score are provided in M. Ojala and G. Garriga, “Permutation Tests for Studying Classifier Performance,” J. OF MACHINE LEARNING RES., vol. 11 (2010), the entire contents of which are incorporated by reference herein for all purposes.

In a conventional permutation test score, the hypothesis is tested by randomizing the relation between observations and preexisting labels.

In example embodiments, instead of randomizing the relation between observations and preexisting labels, in general the present retraining assessment changes the labels according to the class agreement stage. An example implementation of the permutation test score stage 600 is summarized as follows:
1. Run a first permutation test using the datastream D_{old}, doing n label permutations running the target model M, and store the discrete probability density distribution AccDist_{old} 602a that the first test provides.
2. Run the target model M with features from the datastream D_{old}, but now considering the labels resulting from the class agreement stage, and store the accuracy Accₐₗₗ 604b, for example as a unit value.
3. Run a second permutation test, doing n permutations considering the labels resulting from the class agreement stage, and store the discrete accuracy probability density distribution AccDistₐₗₗ 602b that the second test provides.
4. Check if there is structure between the probability density distribution AccDistₐₗₗ 602b and the accuracy Accₐₗₗ 604b. In some embodiments, the check is represented by a statistically significant low p-value. A low p-value can be visually represented by a high accuracy difference 606b, and it is related to the hypothesis test. More generally, advantageously this check determines whether structure exists between the observations from the datastream D_{old} and the new labels resulting from the class agreement stage.
5. If structure exists between the probability density distribution AccDistₐₗₗ 602b and the accuracy Accₐₗₗ 604b, then analyze the absolute statistical distance s 608 between the respective probability density distributions AccDist_{old} 602a and AccDistₐₗₗ 602b. More generally, the absolute statistical distance provides a useful check to confirm that the advantages of aggregating new features are not caused by chance. In an example embodiment, the statistical distance is computed by applying the Bhattacharyya test, which quantifies the closeness of two random statistical samples. However, different approaches may be applied to compute the statistical distance without departing from the scope of the embodiments disclosed.

A level of deterioration of the target model is expected, but if the new accuracy probability density distribution AccDistₐₗₗ 602b is sufficiently close to the accuracy probability density distribution AccDist_{old} 602a and the permutation test score determines that structure exists between the probability density distribution AccDistₐₗₗ and the accuracy Accₐₗₗ 604b, this indicates that the new features coming from the newly installed sensors can be inferred and expected to enhance the target model's capability. In an example embodiment, the closeness of the respective probability density distributions AccDistₐₗₗ and AccDist_{old} is determined based on an allowed statistical distance s 608. In some embodiments, the closeness is a predetermined threshold that is user-provided. For example, the closeness or permissiveness can be set according to the domain and also considering tradeoffs between model enhancement and the cost of retraining.

FIG. 6 shows an example permutation test score result with a possible outcome of the accuracy Accₐₗₗ 604b. FIG. 6 illustrates an example scenario that precedes the comparison discussed earlier.

More generally, the accuracy Acc_{old} 604a helps demonstrate the original performance of the target model on a non-permutated dataset, where labels are totally reliable. The distance d_{old} 606a between the accuracy Acc_{old} and the probability density distribution AccDist_{old} 602a is large, which relates to a small p-value. As discussed, the probability density distribution AccDist_{old} is determined from swapping the reliable labels with the old features.

As discussed, example embodiments of the permutation test score stage 600 next use the labels resulting from the class agreement stage, with the original features. A loss in accuracy is expected as the accuracy Accₐₗₗ 604b is obtained, and FIG. 6 shows accordingly that Accₐₗₗ<Acc_{old}. Finally, example embodiments swap the labels resulting from the class agreement stage and the respective features, to obtain the probability density distribution AccDistₐₗₗ 602b. It is noted that determining generally whether the p-value from the probability density distribution AccDistₐₗₗ 602b and the accuracy Accₐₗₗ is sufficiently small (as shown by the distance dₐₗₗ 606b between the accuracy Accₐₗₗ and the probability density distribution AccDistₐₗₗ) can be domain-specific and involve individualized preferences and considerations, as discussed in further detail herein. If the p-value is sufficiently small, this check confirms there is a structure between the features and the new labels. Accordingly, the permutation test score stage 600 analyzes the statistical difference s 608 between the respective probability density distributions AccDist_{old} 602a and AccDistₐₗₗ 602b to determine a difference measurement between them.

As discussed, if the check confirms there is a structure between the features and the new labels, then the absolute statistical distance s 608 between the respective probability density distributions AccDist_{old} 602a and AccDistₐₗₗ 602b is calculated and a decision is made upon this difference measurement, in view of the desired use case. For example, the resulting decision can include whether to enhance the target model by retraining the target model to incorporate the features.

The resulting decision informs whether the retraining of a target model with inputs including both kinds of sensors (e.g., preexisting and newly installed) would be beneficial, depending on considerations and preferences determined by the domain and by the user. For example, even if the permutation test score indicates a drop in performance with respect to the original model, such a performance drop may be acceptable in exchange for advantages offered by the increased generalization. Advantageously, the disclosed techniques help to rule out many scenarios in which the retraining of a target model, with a new modality of sensors, would not be useful due to a high estimated drop in performance.

### D. Example Methods

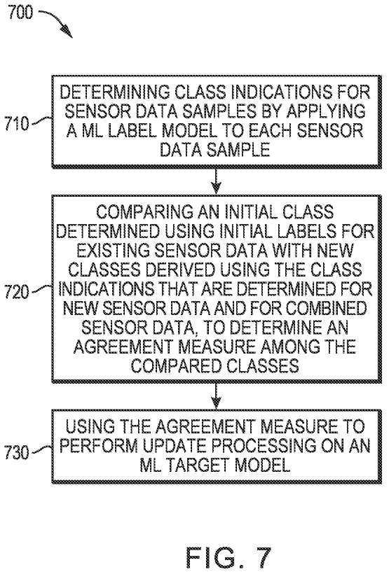

FIG. 7 shows a flowchart of an example method 700, in accordance with illustrative embodiments. In example embodiments, the method 700 allows for model retraining assessment.

In some embodiments, the method 700 can be performed by the present retraining assessment solution 200, such as using the service 210.

In example embodiments, the method 700 includes determining class indications for sensor data samples by applying a ML label model to each sensor data sample (step 710). Some embodiments of the sensor data samples include a dataset obtained from preinstalled sensors, thereby defining existing sensor data. In further embodiments, the sensor data samples include a dataset obtained from newly installed sensors, thereby defining new sensor data. In some embodiments, the sensor data samples include a dataset obtained by combining the preinstalled and the newly installed sensors, thereby defining combined sensor data. In some implementations, the class indication is determined based on a probability per class, thereby defining a class probability, and the class probability is obtained from the label model using one or more labeling functions. In some embodiments, the class indication includes an indicator that represents whether the class probability exceeds a predetermined threshold. In further embodiments, the indicator is a Boolean indicator. In some embodiments, the label model is trained using programmatic labeling.

In example embodiments, the method 700 includes comparing an initial class determined using initial labels for the existing sensor data with new classes derived using the class indications that are determined for the new sensor data and for the combined sensor data, to determine an agreement measure among the compared classes (step 720). Some embodiments of the initial labels are determined using a label model LabelModel_{old}, or using golden labels obtained from an oracle for the existing sensor data. In some embodiments, the new classes are determined using a label model LabelModel_{new} that is applied to the new sensor data, and using a label model LabelModel_{both} that is applied to the combined sensor data. In further embodiments, the new classes are determined by using the label models LabelModel_{new} and LabelModel_{both} to obtain class probabilities for the new sensor data and for the combined sensor data respectively at a given timestamp; and using the class probabilities to determine respective class indications representing the new classes.

In example embodiments, the method 700 includes using the agreement measure to perform update processing on an ML target model (step 730). In some embodiments, the update processing comprises determining that the agreement measure indicates agreement among at least a subset of the compared classes that a given label represents the class for the corresponding dataset at a given timestamp, and, in response to the agreement, enhancing the target model by retraining the target model to incorporate features represented by the new sensor data or by the combined sensor data. In further embodiments, a magnitude of the enhancement is derived using a permutation test score that is determined based on the agreement measure. In some embodiments, the update processing comprises determining that the agreement measure indicates disagreement among the compared classes that a given label represents the class for the sensor data samples, and, in response to the disagreement, refraining from retraining the target model to incorporate features represented by the sensor data samples from the newly installed sensor. In some embodiments, the target model is a classifier model.

While the various steps in the example method 700 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example method 700 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

At least portions of the present retraining assessment system can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the present retraining assessment system. For example, containers can be used to implement respective processing devices providing compute and/or storage services of a cloud-based system. Again, containers may be used in combination with other virtualization infrastructure such as virtual machines implemented using a hypervisor.

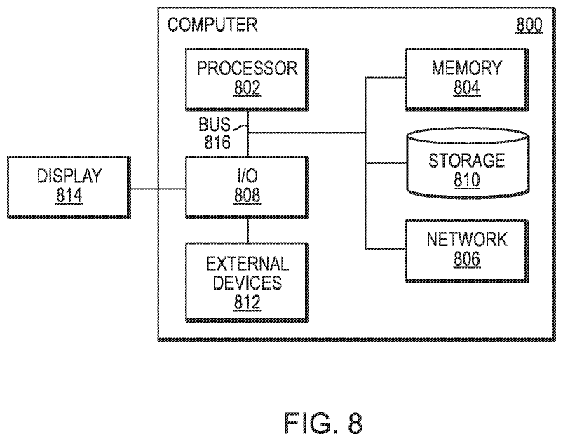

Illustrative embodiments of processing platforms will now be described in greater detail with reference to FIG. 8. Although described in the context of the present retraining assessment system, these platforms may also be used to implement at least portions of other information processing systems in other embodiments.

FIG. 8 illustrates aspects of a computing device or a computing system in accordance with example embodiments. The computer 800 is shown in the form of a general-purpose computing device. Components of the computer may include, but are not limited to, one or more processors or processing units 802, a memory 804, a network interface 806, and a bus 816 that communicatively couples various system components including the system memory and the network interface to the processor.

The bus 816 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 800 typically includes a variety of computer-readable media. Such media may be any available media that is accessible by the computer system, and such media includes both volatile and non-volatile media, removable and non-removable media.

The memory 804 may include computer system readable media in the form of volatile memory, such as random-access memory (RAM) and/or cache memory. The computer system may further include other removable/non-removable, volatile/non-volatile computer system storage media. By way of example only, the storage system 810 may be provided for reading from and writing to a non-removable, non-volatile magnetic media (not shown and typically called a “hard drive”) in accordance with the present retraining assessment techniques. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 816 by one or more data media interfaces. As has been depicted and described above in connection with FIGS. 1-7, the memory may include at least one computer program product having a set (e.g., at least one) of program modules that are configured to carry out the functions of the embodiments as described herein.

The computer 800 may also include a program/utility, having a set (at least one) of program modules, which may be stored in the memory 804 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 800 may also communicate with one or more external devices 812 such as a keyboard, a pointing device, a display 814, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 808. Still yet, the computer system may communicate with one or more networks such as a local area network (LAN), a general wide area network (WAN), and/or a public network (e.g., the Internet) via the network adapter 806. As depicted, the network adapter communicates with the other components of the computer system via the bus 816. It should be understood that although not shown, other hardware and/or software components could be used in conjunction with the computer system. Non-limiting examples include microcode, device drivers, redundant processing units, external disk drive arrays, RAID systems, tape drives, data archival storage systems, and the like.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

In the foregoing description of FIGS. 1-8, any component described with regard to a figure, in various embodiments of the invention, may be equivalent to one or more like-named components described with regard to any other figure. For brevity, descriptions of these components has not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the disclosure, ordinal numbers (e.g., first, second, third, etc.) may have been used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this disclosure, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.” This labeling convention means that the data structure may include any number of the elements. A second data structure, also labeled as “a” to “n,” may also include any number of elements. The number of elements of the first data structure and the number of elements of the second data structure may be the same or different.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the embodiments described herein should be limited only by the appended claims.

What is claimed is:

1. A system comprising:
at least one processing device including a processor coupled to a memory;
the at least one processing device being configured to implement the following steps:
determining class indications for sensor data samples by applying a machine-learning (ML) label model to each sensor data sample, the sensor data samples including a dataset obtained from preinstalled sensors thereby defining existing sensor data, a dataset obtained from newly installed sensors thereby defining new sensor data, and a dataset obtained by combining the preinstalled and the newly installed sensors thereby defining combined sensor data;
comparing an initial class determined using initial labels for the existing sensor data with new classes derived using the class indications that are determined for the new sensor data and for the combined sensor data, to determine an agreement measure among the compared classes; and
using the agreement measure to perform update processing on an ML target model.

2. The system of claim 1, wherein the update processing comprises:
determining that the agreement measure indicates agreement among at least a subset of the compared classes that a given label represents the class for the corresponding dataset at a given timestamp, and
in response to the agreement, enhancing the target model by retraining the target model to incorporate features represented by the new sensor data or by the combined sensor data.

3. The system of claim 2, wherein a magnitude of the enhancement is derived using
a permutation test score that is determined based on the agreement measure.

4. The system of claim 1, wherein the update processing comprises:
determining that the agreement measure indicates disagreement among the compared classes that a given label represents the class for the sensor data samples, and
in response to the disagreement, refraining from retraining the target model to incorporate features represented by the sensor data samples from the newly installed sensor.

5. The system of claim 1, wherein the initial labels are determined using a label model LabelModel_{old}, or using golden labels obtained from an oracle for the existing sensor data.

6. The system of claim 1, wherein the new classes are determined using a label model LabelModel_{new} that is applied to the new sensor data, and using a label model LabelModel_{both} that is applied to the combined sensor data.

7. The system of claim 6, wherein the new classes are determined by:
using the label model LabelModel_{new} and LabelModel_{both} to obtain class probabilities for the new sensor data and for the combined sensor data respectively at a given timestamp; and
using the class probabilities to determine respective class indications representing the new classes.

8. The system of claim 1, wherein the class indication is determined based on a probability per class, thereby defining a class probability, and the class probability is obtained from the label model using one or more labeling functions.

9. The system of claim 8, wherein the class indication includes an indicator that represents whether the class probability exceeds a predetermined threshold.

10. The system of claim 9, wherein the indicator is a Boolean indicator.

11. The system of claim 1, wherein the label model is trained using programmatic labeling.

12. The system of claim 1, wherein the target model is a classifier model.

13. A method comprising:
determining class indications for sensor data samples by applying a machine-learning (ML) label model to each sensor data sample, the sensor data samples including a dataset obtained from preinstalled sensors thereby defining existing sensor data, a dataset obtained from newly installed sensors thereby defining new sensor data, and a dataset obtained by combining the preinstalled and the newly installed sensors thereby defining combined sensor data;
comparing an initial class determined using initial labels for the existing sensor data with new classes derived using the class indications that are determined for the new sensor data and for the combined sensor data, to determine an agreement measure among the compared classes; and
using the agreement measure to perform update processing on an ML target model.

14. The method of claim 13, wherein the update processing comprises:
determining that the agreement measure indicates agreement among at least a subset of the compared classes that a given label represents the class for the corresponding dataset at a given timestamp, and
in response to the agreement, enhancing the target model by retraining the target model to incorporate features represented by the new sensor data or by the combined sensor data.

15. The method of claim 14, wherein a magnitude of the enhancement is derived using a permutation test score that is determined based on the agreement measure.

16. The method of claim 13, wherein the update processing comprises:
determining that the agreement measure indicates disagreement among the compared classes that a given label represents the class for the sensor data samples, and
in response to the disagreement, refraining from retraining the target model to incorporate features represented by the sensor data samples from the newly installed sensor.

17. The method of claim 13, wherein the initial labels are determined using a label model LabelModel_{old}, or using golden labels obtained from an oracle for the existing sensor data.

18. The method of claim 13, wherein the new classes are determined using a label model LabelModel_{new} that is applied to the new sensor data, and using a label model LabelModel_{both} that is applied to the combined sensor data.

19. The method of claim 18, wherein the new classes are determined by:
using the label model LabelModel_{new} and LabelModel_{both} to obtain class probabilities for the new sensor data and for the combined sensor data respectively at a given timestamp; and
using the class probabilities to determine respective class indications representing the new classes.

20. A non-transitory processor-readable storage medium having stored thereon program code of one or more software programs, wherein the program code when executed by at least one processing device causes the at least one processing device to perform the following steps:
determining class indications for sensor data samples by applying a machine-learning (ML) label model to each sensor data sample, the sensor data samples including a dataset obtained from preinstalled sensors thereby defining existing sensor data, a dataset obtained from newly installed sensors thereby defining new sensor data, and a dataset obtained by combining the preinstalled and the newly installed sensors thereby defining combined sensor data;
comparing an initial class determined using initial labels for the existing sensor data with new classes derived using the class indications that are determined for the new sensor data and for the combined sensor data, to determine an agreement measure among the compared classes; and
using the agreement measure to perform update processing on an ML target model.
